(19) United States
(12) Patent Application Publication
(10) Pub. No.: US 2011/0093239 A1
(43) Pub. Date: Apr. 21, 2011

(54) VEHICLE WEIGHT SENSING METHODS AND SYSTEMS

(76) Inventors: Gregory A. Holbrook, Zionsville, IN (US); Joseph A. Bounds, Fishers, IN (US)

(21) Appl. No.: 12/909,349

(22) Filed: Oct. 21, 2010

Related U.S. Application Data
(60) Provisional application No. 61/253,609, filed on Oct. 21, 2009.

(51) Int. Cl. G01G 19/10; G06F 15/00

(52) U.S. Cl. 702/174

(57) ABSTRACT

Disclosed are vehicle weight sensing methods and systems. According to one aspect of this disclosure, provided is a method of characterizing a vehicle to determine gross axle weights by accessing a computer readable database which correlates a plurality of pressures associated with fluid suspension members incorporated into the vehicle.

This application claims priority from U.S. Provisional Patent Application No 61/253,609, filed Oct. 21, 2009, by Holbrook et al., entitled “VEHICLE WEIGHT SENSING METHODS AND SYSTEMS,” and is incorporated herein by reference in its entirety.

### BACKGROUND

This disclosure generally relates to the art of vehicle suspension systems, and more particularly, to methods and systems of sensing a load on a vehicle having a fluid suspension system.

The present novel concepts, and exemplary embodiments thereof, find particular application and use in conjunction with fluid suspension systems of wheeled vehicles, and will be described herein with specific reference thereto. However, it is to be appreciated that the present novel concept is also amenable to use in other applications and environments, and that the specific uses shown and described herein are merely exemplary.

Vehicles, such as relatively light-duty wheeled vehicles (e.g. passenger vehicles, pick-up trucks and sport utility vehicles) continue to advance in complexity and sophistication, the systems thereof make greater and greater use of data, signals and/or information relating to performance and other conditions (e.g. speed, vehicle height, vehicle orientation) of a vehicle as well as various inputs (e.g. road impact forces) acting thereon. Such data, signals and/or information may be utilized by systems such as automatic braking systems, suspension systems, traction central systems and stability control systems, tire pressure monitoring systems and/or tire inflation systems, for example.

One additional input or condition of a vehicle that can be utilized by such systems is the external load acting on the vehicle, such as from passengers and/or cargo. For example, U.S. Pat. No. 4,651,838 ('838) issued to Hamilton et al. and entitled “Air Spring Control System and Method,” discloses a microprocessor based air spring control system to determine the weight and loading of a chassis supported by the air springs. In operation, the '838 air spring control system measures the air pressure associated with an air spring to determine the weight of a load supported by the air spring suspension system. A look-up table (LUT) representing the operating characteristics of the air spring, i.e. load versus deflection at constant pressure, is used by a microprocessor to determine the weight of the chassis. To generate the LUT, a calibration procedure is performed which calculates the data based on known characteristics of the air springs and varying the air spring pressures at incremental time intervals.

Another example of an air spring system is U.S. Pat. No. 4,832,141 ('141) issued to Perini et al. and entitled “Vehicle Mounted Load Indicator System.” The '141 patent discloses a vehicle mounted air spring system which measures the air pressure associated with an air bag and accesses a LUT to determine the weight of the load supported by the chassis. The LUT represents the loading characteristics of the air bags and is stored in a PROM. To calibrate the system and generate the LUT, a load of known weight is placed on the platform of the vehicle and the resultant air pressure change is measured.

Other examples of known air spring vehicle weight and/or load measurement systems include U.S. Pat. No. 5,478,974 issued to O'Dea entitled On-Board Vehicle Weighing System“; U.S. Pat. No. 5,780,783 issued to Heider et al., entitled “Vehicle Load Weighing System”; and U.S. Pat. No. 6,915,884, issued to Glazier, entitled “Load Sensing System.”

One attribute associated with known vehicle and load weight measurement systems, as discussed above, is the need for relatively time consuming and complex calibration procedures to generate the appropriate data for determining the weight of a load based on the air bag/air spring pressure.

This disclosure, and the exemplary embodiments provided herein, provide vehicle load sensing methods and systems which access a database to determine the weight of the vehicle and/or supported load. The database correlates the pressure associated with one or more fluid suspension members to provide vehicle/load weight and is generated by novel methods of characterizing the vehicle.

### INCORPORATION BY REFERENCE

The following are incorporated herein by reference in their entirety.

U.S. Pat. No. 4,651,838, issued to Hamilton et al. on Mar. 24, 1987 and entitled “AIR SPRING CONTROL SYSTEM AND METHOD.”

U.S. Pat. No. 4,718,650, issued to Geno on Jan. 12, 1988 and entitled “AIR SPRING FOR VEHICLE.”

U.S. Pat. No. 4,712,776, issued to Geno et al. on Dec. 15, 1987 and entitled “AIR SPRING SUSPENSION SYSTEM.”

U.S. Pat. No. 4,798,369, issued to Geno et al. on Jan. 17, 1989 and entitled “ULTRASONIC AIR SPRING SYSTEM.”

U.S. Pat. No. 4,832,141, issued to Perini et al. on May 23, 1989 and entitled “VEHICLE MOUNTED LOAD INDICATOR SYSTEM.”

U.S. Pat. No. 4,852,861, issued to Harris on Aug. 1, 1989 and entitled “END CAP ASSEMBLY FOR AIR SPRING.”

U.S. Pat. No. 5,229,829, issued to Nihei et al. on Jul. 20, 1993 and entitled “HEIGHT SENSOR AND AIR CUSHION.”

U.S. Pat. No. 5,374,037, issued to Bledsoe on Dec. 20, 1994 and entitled “CLAMP RING ASSEMBLY FOR AIR SPRING.”

U.S. Pat. No. 5,478,974, issued to O'Dea on Dec. 26, 1995 and entitled “ON-BOARD VEHICLE WEIGHING SYSTEM.”

U.S. Pat. No. 5,707,045, issued to Easter on Jan. 13, 1998 and entitled “AIR SPRING SYSTEM HAVING AN INTEGRAL HEIGHT SENSOR.”

U.S. Pat. No. 5,780,783, issued to Heider et al. on Jul. 14, 1998 and entitled “VEHICLE LOAD WEIGHING SYSTEM.”

U.S. Pat. No. 6,915,884, issued to Glazier on Jul. 12, 2005 and entitled “LOAD SENSING SYSTEM.”

U.S. Pat. No. 7,357,397, issued to Brookes et al. on Apr. 15, 2008 and entitled “METHOD AND SYSTEMS FOR ALIGNING A STATIONARY VEHICLE WITH AN ARTIFICIAL HORIZON.”

### BRIEF DESCRIPTION

In one embodiment of this disclosure, a first method of characterizing a vehicle to determine gross axle weights associated with the vehicle is disclosed wherein the vehicle includes a sprung mass operatively associated with supporting a payload, an unsprung mass including two or more axles, and a fluid suspension system operatively associated with supporting the sprung mass and controlling the height of the sprung mass relative to the unsprung mass, the fluid suspension system including one or more fluid suspension members operatively disposed between the sprung mass and the axles, a fluid control device, a pressurized fluid source, an exhaust passage in fluid communication with the one or more fluid suspension members through the fluid control device, one or more pressure sensors operatively associated with the fluid suspension members, and an electronic control unit operatively associated with the fluid control device, the method of characterizing the vehicle comprising: measuring a first gross axle weight of each axle of the vehicle unloaded; adjusting the height of the sprung mass, relative to the unsprung mass, to a predetermined height by one of supplying fluid to the fluid suspension members and exhausting fluid from the fluid suspension members; measuring a first pressure associated with each of the fluid suspension members; loading the sprung mass with a characterization load; measuring a second gross axle weight of each axle of the vehicle loaded with the characterization load; adjusting the height of the sprung mass, relative to the unsprung mass, to the predetermined height by one of supplying fluid to the one or more fluid suspension members and exhausting fluid from the one or more fluid suspension members; measuring a second pressure associated with each of the fluid suspension members; and creating a computer readable database which correlates a plurality of pressures associated with the fluid suspension members with a gross axle weights of the respective axles with the fluid suspension members supporting the sprung mass at the predetermined height, wherein the first gross axle weights and the respective measured first pressures provide a first data set, and the second gross axle weights and the respective measured second pressures provide a second data set to create the database.

In a second embodiment of this disclosure, a second method of characterizing a vehicle to determine gross axle weights associated with the vehicle is disclosed wherein the vehicle includes a sprung mass operatively associated with supporting a payload, an unsprung mass including two or more axles, and a fluid suspension system operatively associated with supporting the sprung mass and controlling the height of the sprung mass relative to the unsprung mass, the fluid suspension system including one or more fluid suspension members operatively disposed between the sprung mass and the axles, a fluid control device, a pressurized fluid source, an exhaust passage in fluid communication with the fluid suspension members through the fluid control device, one or more pressure sensors operatively associated with the fluid suspension members, and an electronic control unit operatively associated with the fluid control device, the method of characterizing the vehicle comprising: measuring gross axle weight of each axle with the vehicle unloaded; adjusting the height of the sprung mass, relative to the unsprung mass, to a predetermined height by one of supplying fluid to the fluid suspension members and exhausting fluid from the fluid suspension members; measuring a first pressure associated with each of the fluid suspension members; determining a second gross axle weight of each axle for a second pressure associated with the fluid suspension members, the second pressure greater than the first pressure and the second gross axle weight of the axles determined by accessing load data associated with the fluid suspension members, wherein the load data provides one or more sprung mass weights for one or more respective pressures associated with the fluid suspension members at a height associated with the predetermined sprung mass height, and the second gross axle weight of the axles is calculated as a function of the first gross axle weight, the first pressure, the sprung mass weight for the second pressure and the second pressure; and creating a computer readable database which correlates a plurality of pressures associated with the fluid suspension members with a plurality of gross axle weights of the respective axles with the fluid suspension members supporting the sprung mass at the predetermined height, wherein the first gross axle weights and the respective measured first pressures provide a first data set, and the second gross axle weights and the respective measured second pressures provide a second data set to create the database.

In still another embodiment of this disclosure, disclosed is a third method of measuring the gross axle weight of each axle associated with a vehicle, the vehicle including a sprung mass operatively associated with supporting a payload, an unsprung mass, and a fluid suspension system operatively associated with supporting the sprung mass and controlling the height of the sprung mass relative to the unsprung mass including two or more axles, the fluid suspension system including one or more fluid suspension members operatively disposed between the sprung mass and the axles, a fluid control device, a pressurized fluid source, an exhaust passage in fluid communication with the one or more fluid suspension members through the fluid control device, one or more pressure sensors operatively associated with the fluid suspension members, and an electronic control unit operatively associated with the fluid control device, the method of measuring the gross axle weight of each axle comprising: adjusting the height of the sprung mass, relative to the unsprung mass, to a predetermined height by one of supplying fluid to the one or more fluid suspension members and exhausting fluid from the one or more fluid suspension members; measuring a pressure associated with the fluid suspension members; and the electronic control unit, determining the gross axle weight of each axle by accessing a computer readable database which correlates the pressure associated with the fluid suspension members with the gross axle weight of the axle and the fluid suspension members supporting the sprung mass at the predetermined height, wherein the computer readable database is generated by the first method described above.

In a still further embodiment of this disclosure, a fourth method of measuring the gross axle weight of each axle associated with a vehicle is disclosed wherein the vehicle includes a sprung mass operatively associated with supporting a payload, an unsprung mass including two or more axles, and a fluid suspension system operatively associated with supporting the sprung mass and controlling the height of the sprung mass relative to the unsprung mass, the fluid suspension system including one or more fluid suspension members operatively disposed between the sprung mass and the axles, a fluid control device, a pressurized fluid source, an exhaust passage in fluid communication with the fluid suspension members through the fluid control device, one or more pressure sensors operatively associated with the one or more fluid suspension members, and an electronic control unit operatively associated with the fluid control device, the method of measuring the gross axle weight of each axle comprising: adjusting the height of the sprung mass, relative to the unsprung mass, to a predetermined height by one of supplying fluid to the one or more fluid suspension members and exhausting fluid from the one or more fluid suspension members; measuring a pressure associated with the one or more fluid suspension members; and the electronic control unit, determining the gross axle weight of each axle by accessing a computer readable database which correlates the pressure associated with the fluid suspension members with the gross axle weight of the axle and the fluid suspension members supporting the sprung mass at the predetermined height, wherein the computer readable database is generated by the second method described above.

In another embodiment of this disclosure, disclosed is a first gross axle weight measurement and display system for a vehicle including an unsprung mass and a sprung mass operatively associated with supporting a payload comprising: one or more fluid suspension members operatively disposed between the sprung mass and the unsprung mass; a fluid control device; a pressurized fluid source; an exhaust passage in fluid communication with the one or more fluid suspension members through the fluid control device; one or more pressure sensors operatively associated with the one or more fluid suspension members; a height sensor operatively associated with measuring the height of the sprung mass relative to the unsprung mass; a display unit; and an electronic control unit operatively associated with the fluid control device, the one or more pressure sensors, the height sensor, and the display unit, the electronic control unit configured to execute instructions that, when executed by the control unit, cause the control unit to perform a method comprising: determining that the sprung mass is at a predetermined height relative to the unsprung mass by communicating with the height sensor; communicating with the one or more pressure sensors to measure the pressure associated with the one or more fluid suspension members with the height of the sprung mass at the predetermined height relative to the unsprung mass; accessing a computer readable database which correlates the pressure associated with the one or more fluid suspension members with the gross axle weight of each axle and the fluid suspension members supporting the sprung mass at the predetermined height, the computer readable database including a first data set associated with a first gross axle weight and a respective measured first pressure, and a second data set associated with a second gross axle weight and a respective second pressure, the first and second data sets generated by the first method described above, and calculating the gross axle weights as a function of the measured pressure, the first data set and the second data set; and communicating the calculated gross axle weights to the display unit.

In a further embodiment of this disclosure, disclosed is a second gross axle weight measurement and display system for a vehicle including an unsprung mass and a sprung mass operatively associated with supporting a payload comprising: one or more fluid suspension members operatively disposed between the sprung mass and the unsprung mass; a fluid control device; a pressurized fluid source; an exhaust passage in fluid communication with the one or more fluid suspension members through the fluid control device; one or more pressure sensors operatively associated with the one or more fluid suspension members; a height sensor operatively associated with measuring the height of the sprung mass relative to the unsprung mass; a display unit; and an electronic control unit operatively associated with the fluid control device, the one or more pressure sensors, the height sensor and the display unit, the electronic control unit configured to execute instructions that, when executed by the control unit, cause the control unit to perform a method comprising: a) determining that the sprung mass is at a predetermined height relative to the unsprung mass by communicating with the height sensor; b) communicating with the one or more fluid suspension members to measure the pressure associated with the one or more pressure sensors with the height of the sprung mass at the predetermined height relative to the unsprung mass; c) accessing a computer readable database which correlates the pressure associated with the fluid suspension members with the gross axle weight of each axle and the fluid suspension members supporting the sprung mass at the predetermined height, the computer readable database including a first data set associated with a first gross axle weight and a respective measured first pressure, and a second data set associated with a second gross axle weight and a respective second pressure, the first and second data sets generated by the second method described above; d) calculating the vehicle weight as a function of the measured pressure and the first data set and the second data set; and e) communicating the calculated gross axle weight to the display unit.

In another embodiment of this disclosure, a fifth method is disclosed of measuring the gross axle weights of a vehicle, the vehicle including a sprung mass operatively associated with supporting a payload, an unsprung mass including two or more axles, and a fluid suspension system operatively associated with supporting the sprung mass and controlling the height of the sprung mass relative to the unsprung mass, the fluid suspension system including one or more fluid suspension members operatively disposed between the sprung mass and the axles, a fluid control device, a pressurized fluid source, an exhaust passage in fluid communication with the fluid suspension members through the fluid control device, one or more pressure sensors operatively associated with the fluid suspension members, a height sensor operatively associated with measuring the height of the sprung mass relative to the unsprung mass, and an electronic control unit operatively associated with the fluid control device, the method of measuring the gross axle weight of each axle comprising: a) measuring a pressure associated with the one or more fluid suspension members; b) measuring a height associated with the sprung mass relative to the unsprung mass; and c) the electronic control unit, determining the gross axle weight of each axle by accessing a computer readable memory which provides a data representation of a mathematical model to calculate the gross axle weight of each axle as a function of the pressure associated with the fluid suspension members and the height associated with the sprung mass relative to the unsprung mass.

In still another embodiment of this disclosure, disclosed is a third gross axle weight measurement and display system for a vehicle including an unsprung mass and a sprung mass operatively associated with supporting a payload comprising: one or more fluid suspension members operatively disposed between the sprung mass and the unsprung mass; a fluid control device; a pressurized fluid source; an exhaust passage in fluid communication with the fluid suspension members through the fluid control device; one or more pressure sensors operatively associated with the fluid suspension members; a height sensor operatively associated with measuring the height of the sprung mass relative to the unsprung mass; a display unit; and an electronic control unit operatively associated with the fluid control device, the one or more pressure sensors, the height sensor, and the display unit, the electronic control unit configured to execute instructions that, when executed by the control unit, cause the control unit to perform a method comprising: a) measuring a pressure associated with the fluid suspension members; b) measuring a height associated with the sprung mass relative to the unsprung mass; c) determining the gross axle weight of each axle by accessing a computer readable memory which provides a data representation of a mathematical model to calculate the gross axle weight of each axle as a function of the pressure associated with the fluid suspension members and the height associated with the sprung mass relative to the unsprung mass; and d) communicating the calculated gross axle weight to the display unit.

### BRIEF DESCRIPTION OF THE DRAWINGS

FIG. 1 is a schematical representation of a vehicle payload weight measurement and display system according to an exemplary embodiment of this disclosure.

FIG. 2 is a diagrammatic side view of a vehicle incorporating a payload weight measurement system according to an exemplary embodiment of this disclosure.

FIG. 3 is a sectional view of line A-A in FIG. 2.

FIG. 4 is a sectional view of line B-B in FIG. 3.

FIG. 5 is a diagrammatic view of a cab mounted control panel/display according to an exemplary embodiment of this disclosure.

FIG. 6 is a flowchart representing a method of characterizing a vehicle to determine the weight of a payload according to an exemplary embodiment of this disclosure. The exemplary characterization method includes the weight measurement of an unloaded vehicle at a predetermined height and the weight measurement of a loaded vehicle at the predetermined height.

FIG. 7 is a flow chart representing a method of characterizing a vehicle to determine the weight of a payload according to another exemplary embodiment of this disclosure. The exemplary characterization method includes the weight measurement of an unloaded vehicle at a predetermined height and determining a loaded vehicle weight based on performance data associated with one or more fluid suspension members (e.g. air springs).

FIG. 8 is a graphical representation of an air spring loading characterization, according to an exemplary embodiment of this disclosure.

FIG. 9 is a flow chart representing a method of measuring the weight of a payload supported by a vehicle including a fluid suspension system according to an exemplary embodiment of this disclosure. The exemplary payload weight measurement method includes accessing a database representing the characterization of a vehicle as represented by the flow chart of FIGS. 6 and 7.

FIG. 10 is a flow chart representing a method of measuring and displaying the weight of a payload supported by a vehicle including a fluid suspension system according to another exemplary embodiment of this disclosure. The exemplary payload weight measurement method includes accessing a database representing a mathematical model of the vehicle.

### DETAILED DESCRIPTION

It is to be understood that the term “chassis,” as recited herein, generally refers to the sprung mass of a vehicle, which typically includes one or more components supported on a fluid suspension member (e.g. air springs). This can include, but is not limited to, a frame, a subframe, a floor and/or a body of the vehicle, for example. In addition, the term unsprung mass generally refers to the components of a vehicle which are not part of the chassis, i.e. components of a vehicle which are not supported by fluid suspension members. Typical examples of components included in the unsprung mass are tires, axle and fluid suspension members. Additionally, the term payload, as recited herein, refers generally to the load carried by a vehicle, such as cargo and passengers.

It is to be understood that the term “Gross Vehicle Weight” (GVW), as recited herein, generally refers to the actual weight of a vehicle, including any cargo, payload, passengers, etc.

It is to be understood that the term “Gross Vehicle Weight Rating” (GVWR), as recited therein, generally refers to the weight limit for a vehicle. In other words, the maximum GVW recommended for a vehicle.

It is to be understood that the term “Gross Axle Weight” (GAW), as recited herein, generally refers to the actual weight of an axle, including any load supported by the axle, i.e. the vehicle's sprung mass.

It is to be understood that the term “curb weight,” as recited herein, generally refers to the GVW of a vehicle without any cargo, payload, passengers, etc.

It is to be understood that the term “ride height,” as recited herein, generally refers to the normal height of the vehicle sprung mass relative to the ground during movement of a vehicle.

It is to be understood that the term “vehicle weight measurement,” as recited herein, generally refers to the weight measurement of any part of a vehicle. For example, but not limited to, the axle weight measurement, vehicle corner weight measurement, etc.

As briefly discussed in the background section, this disclosure relates to the art of vehicle suspension systems, and more particularly, to methods and systems of sensing and measuring the GVW, GAW and/or payload weight of a vehicle having a fluid suspension system. In general, the vehicle includes a sprung mass supporting a payload, an unsprung mass and a fluid suspension system operatively associated with supporting the loaded sprung mass. In addition, the fluid suspension system includes one or more fluid suspension members (e.g. air springs) operatively disposed between the sprung mass and the unsprung mass, i.e. the vehicle chassis and the vehicle axle, a fluid control device, a pressurized fluid source, an exhaust passage in fluid communication with the one or more fluid suspension members through the fluid control device, and one or more pressure sensors to measure the pressure within the fluid suspension members. Additionally, an electronic control unit controls the supply and exhaust of fluid to/from the fluid suspension members, processes signals from the pressure sensors, calculates the axle/vehicle/payload weight based on the methods disclosed herein, and communicates the axle/vehicle/payload weight to a cab mounted display. A cab mounted display can provide a visual indication of the axle/vehicle/payload weight to the driver.

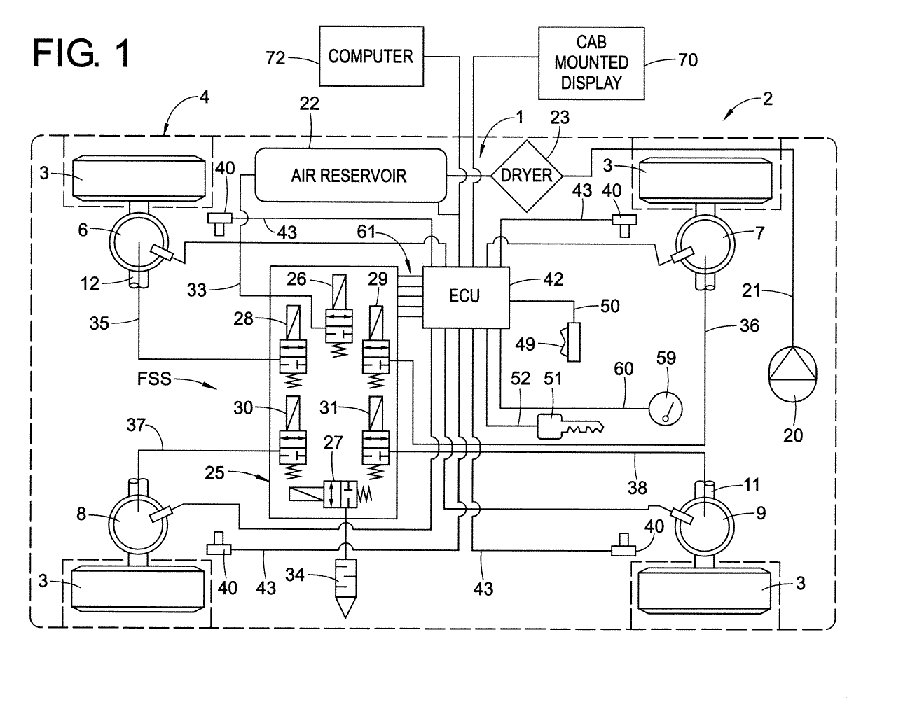

With reference to FIG. 1, illustrated is a schematical representation of a vehicle weight measurement system according to an exemplary embodiment of this disclosure.

The vehicle weight measurement system is indicated generally at 1, and illustrated as being used on a vehicle 2, such as a pick-up truck, a van or a cargo truck. Notably, the system 1 can be used on other types of vehicles, such as travel trailers, RVs, over-the-road truck trailers, ambulances, personnel transport vehicles, etc. The system 1 can also be used on stationary equipment, such as a cargo loading platform, a gun platform, or any other type of platform supported by one or more fluid suspension members, such as air or gas springs. Vehicle 2 includes a plurality of wheels 3, and a fluid suspension system FSS. The fluid suspension system includes air springs 6, 7, 8 and 9 mounted adjacent each wheel 3 on the ends of supporting front and rear axles 11 and 12 and supports a vehicle chassis 4 thereon. For smaller type vehicles, only one pair of air springs may be required.

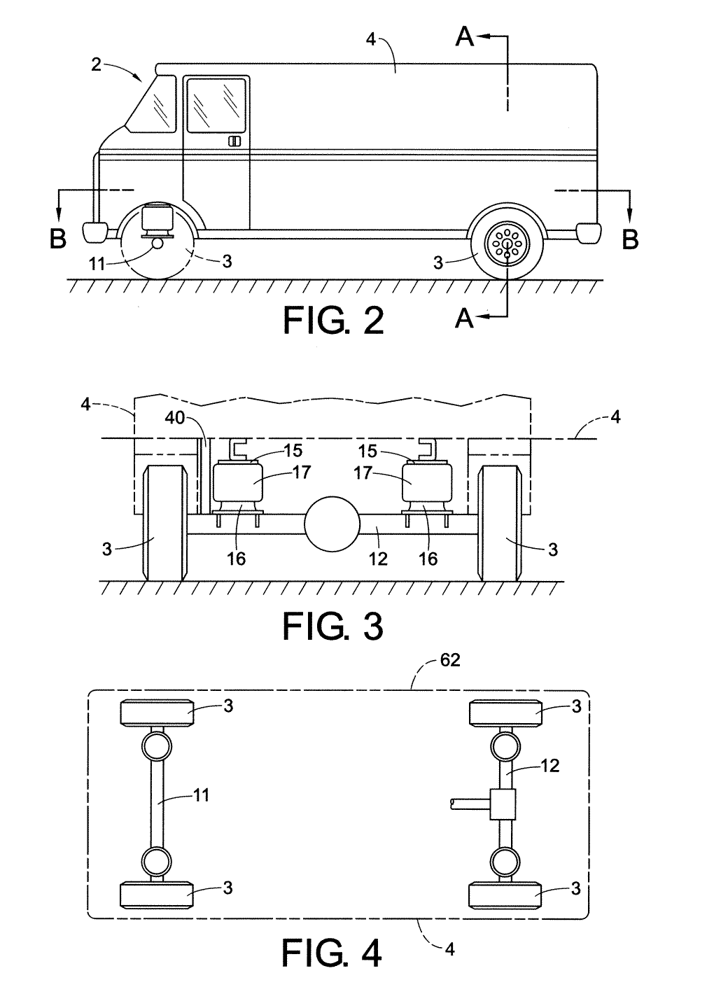

The air springs are of a usual construction having a pair of spaced end members 15 and 16 (FIGS. 2 and 3) with an intervening flexible sleeve 17 forming an internal fluid chamber. Some examples of known air springs are disclosed in U.S. Pat. Nos. 5,374,037, 4,852,861 and 4,718,650, which are totally incorporated by reference herein. Air-over-damper type suspension members also can be used and are within the scope of this disclosure. U.S. Pat. No. 4,712,776 discloses an air-over-damper type suspension member and is totally incorporated by reference herein.

The vehicle weight measurement system includes a compressor 20, which can be electrically operated or driven by the engine of the vehicle or in another suitable manner, to supply pressurized fluid, usually air, through a supply line 21 to a reservoir or supply tank 22. It will be appreciated that such compressors are known to be operable independent of the engine of the vehicle. A dryer 23 can optionally be included and is preferably fluidically interconnected along line 21 for removing moisture from the pressurized fluid prior to entering reservoir 22. If desired, pressurized fluid can be supplied directly to the air springs from the compressor without first going to reservoir 22.

A main control valve assembly 25 includes an inlet valve 26, an exhaust valve 27 and individual air spring control valves 28, 29, 30 and 31. Inlet valve 26 is in fluid communication with reservoir 22 through fluid supply line 33 and exhaust valve 27 is in fluid communication with an exhaust silencer 34. Individual control valves 28, 29, 30 and 31 are connected in fluid communication with individual air springs 6, 7, 8 and 9, respectively, by fluid lines 35, 36, 37 and 38, respectively. It is to be distinctly understood that valve assembly 25 described above and illustrated in FIG. 1 is merely one example of a suitable valve assembly and that any other suitable arrangement can be used without departing from the principles of the present disclosure. For example, multi-position valves, such as 2-way or 3-way valves for example, could be used in place of one or more of the control valves shown and described.

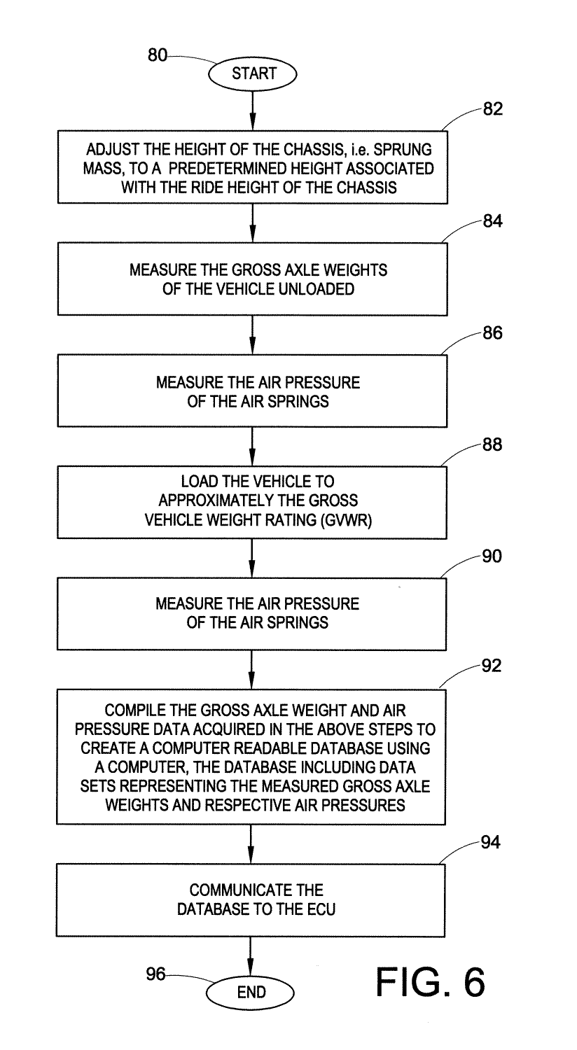

Each of the air springs has a height sensor or detector, indicated generally at 40, associated therewith that can be any one of various known constructions. Height sensors 40 could utilize the Hall effect, sonics, infrared, resistance, or the like, that operate on, in or merely in association with the air springs and of which all are well known in the air spring art. Some examples of such air spring height detectors that are part of an air spring itself are shown in U.S. Pat. Nos. 5,707,045, 5,229,829, and 4,798,369, which are totally incorporated herein by reference. However, as shown in FIG. 6, height sensor 40 can be a separate component externally supported on the vehicle and extending between spaced-apart portions of the vehicle, such as between the axle and chassis or vehicle body, for example. Each height sensor 40 is preferably supported adjacent one of the individual air springs and is also in communication with an electronic control unit (ECU) 42, such as by a control line 43. Additionally, an end-of-travel signal can be output by the height sensors indicating that one of the extreme positions, such as fully extended or fully compressed, for example, of the associated air spring has been reached or is being approached. Alternately, end-of-travel data can be determined by the ECU based upon a comparison of the signal from the height detector with known end-of-travel values stored within the ECU. ECU 42 also is connected to a height switch 49 by a control line 50, to the key actuated vehicle ignition switch 51 by a control line 52, and to a cab mounted display unit 70. Height switch 49 can optionally be a multi-position height selection switch for use when the vehicle is selectively operable at a plurality of heights. ECU 42 also is operatively connected to the vehicle speed indicator or speedometer 59 by a control line 60, and to the individual air spring control valves in valve control unit 25 by a plurality of control lines, indicated collectively at 61. As such, ECU 42 is adapted to selectively actuate one or more of the plurality of valves. It will be appreciated that any suitable speed or movement indicating device can be operatively connected to the ECU in addition to or as an alternative to speedometer 59.

Many of the above-described components and manner of use are standard on many vehicle air suspension systems used for vehicles to provide a multi-position suspension system. Additionally, it will be appreciated that communications to and from the various devices and components of the vehicle, such as ECU 42, height switch 49 and speedometer 59, for example, can be transmitted in any suitable manner. For example, each of the devices and components can be hard-wired to one another as prescribed by each of the various systems operative on the vehicle, with the signals communicated between the devices and components along the individual wires. As an example, if five different systems of the vehicle rely upon a signal from the speedometer, five different wires may be interconnected to the speedometer to provide the signal output by the speedometer to each of the systems directly. However, many vehicles now include a CAN bus communication system that networks the various devices and components together. Such CAN bus communications systems are well known and commonly used. These systems can include a standalone controller or alternately be integrated into another controller of the vehicle, such as ECU 42, for example. One example of a suitable standard or protocol for such systems is SAE J1939. Though, it will be appreciated that a variety of other protocols exist and could alternately be used, such as CANOpen and DeviceNET, for example. One advantage of using a CAN bus communication system is that the actual physical wiring of the vehicle is greatly simplified. Another advantage is that the addition of a new device and/or system can be accomplished without significant physical modification of the vehicle. For example, the new system can be added to the vehicle simply by suitably mounting a new device on the vehicle, placing the device into communication with the CAN bus communication system, and making any attendant software and/or firmware modifications to the existing devices and/or components. Once installed, the new system can send and receive any other signals, information and/or data through the CAN bus communication system to operate the newly added system.

FIGS. 6-10 illustrate various exemplary embodiment methods of characterizing a vehicle for weight measurement and displaying a weight. These exemplary methods will be described below after providing a general description of the methods and systems disclosed herein.

According to one aspect of the disclosed embodiments, procedures are provided to allow a generic vehicle to be characterized for gross axle weight measurement, which can be used to calculate the GVW of a vehicle and/or the payload weight supported by the vehicle. Notably, the term characterization as used herein, refers to a quantification of the vehicle behavior as a function of a weight supported by the chassis, i.e. sprung mass.

One potential benefit associated with the disclosed methods and systems is an end user of a vehicle including a fluid suspension system can characterize the vehicle using the disclosed methods.

As will be further described with reference to FIGS. 6-10, the basic vehicle characterization procedure requires the user to initiate the acquisition of air spring pressure data for the vehicle at ride height and curb weight. In addition, the user is required to acquire the actual curb weight of the vehicle, for example, by use of a drive-on scale which independently measures the weight supported by each wheel operatively attached to each axle, i.e. each “corner” of the vehicle. As discussed above, ride height refers to the normal height of the chassis, relative to the ground, during vehicle movement. Curb weight refers to the weight of the vehicle without any cargo or passengers. It is to be understood the conditions of ride height and curb weight, as described herein, are not meant to limit the application of the disclosed methods and systems. In general, any achievable chassis height and vehicle weight, e.g. curb weight plus 1000 lb., can be used to characterize a vehicle.

After a user weighs the vehicle at curb weight and ride height, and the corresponding air spring pressure is recorded, the user will either perform an additional weighing of the vehicle at or near the gross vehicle weight rating (GVWR) of the vehicle or consult a load data sheet for the air springs and determine a gross vehicle weight associated with the vehicle at the ride height and a second air spring pressure at or near the maximum design load of the air spring.

A program run on a personal computer (PC), but not limited to a PC, leads a user through the characterization process by displaying instructions to the user such as “weigh vehicle at ride height and curb weight.” In addition, the PC will accept vehicle weight data input from the user. In the event it is inconvenient to measure the vehicle at or near the GVWR, the PC program instructs the user to consult a load data sheet for the air springs and enter the corresponding sprung mass weight for the air spring height associated with the ride height of the vehicle, and the corresponding air spring pressure. As previously discussed, it is desirable to use an air spring pressure curve which is representative of an air spring pressure greater than the air spring pressure associated with GVWR to achieve relatively greater accuracy.

To calculate the gross vehicle weight as a function of the load data sheet, the following calculations are performed by the PC.

Assuming that a load data sheet is used, one measurement at curb weight is taken and one linear curve is used for characterization. Note: 110 PSIG data is used for illustration purposes only. It is to be understood that the disclosed methods and systems are not limited to specific data associated with a specific air spring PSIG.

Data obtained during characterization:

Air spring pressure at curb weight.

Curb Weight of vehicle.

Air spring load at 100 PSIG. Note: 100 PSIG, in this example, is associated with the maximum recommended operating pressure for the air spring used.

Gross Vehicle Weight Rating.

Look Up Table generated with the following components:

Air spring pressure at curb weight.

Air spring pressure at Gross Weight Rating.

Curb Weight.

Gross Weight Rating.

Gross Vehicle Weight Rating is entered by the user during the characterization process.

Air spring pressure at Gross Vehicle Weight Rating is derived by the following process:

Air Spring Load at curb weight=(Air spring pressure at curb weight/Air spring pressure at 100 PSIG)*Air spring load at 100 PSIG.

Non air spring load=Curb Weight−Air spring load at curb weight. Air spring load at gross vehicle weight rating=Gross Vehicle Weight Rating−non air spring load.

Air pressure at gross vehicle weight rating=(Air spring load at gross weight/Air spring load at 100 PSIG)*100 (PSIG).

For the case where two pressures and gross vehicle weights are entered in place of using load data sheet:

Data obtained during characterization:

Air spring pressure at curb weight.

Curb Weight.

Air spring pressure at a second load.

Weight at the second load.

Gross Vehicle Weight Rating.

Same Look Up Table as above generated with the following components:

Air spring pressure at curb weight.

Air spring pressure at gross vehicle weight rating.

Curb Weight.

Gross Vehicle Weight Rating.

Air spring pressure at gross vehicle weight rating calculated by the following process.

Pounds Per PSI=(Weight at second load−Curb Weight)/(Air spring pressure at second load−Air spring pressure at Curb Weight).

Air spring pressure at gross vehicle weight rating=((Gross Vehicle Weight Rating−Curb Weight)/Pounds Per PSI)+Air spring pressure at Curb Weight.

According to one exemplary embodiment, the front and rear axle weights on a vehicle are displayed for a four corner air suspensions. Alternatively, only axle weight is displayed for a two corner air suspensions.

After the vehicle weight and air spring pressure data is recorded for at least two effective gross vehicle weights, the PC compiles the data sets to produce a database which is transferred to the ECU associated with the vehicle fluid suspension system. As is known in the art of vehicle electronic control systems, the database can be stored in EPROM, EEPROM, etc.

According to one exemplary embodiment, a table is compiled for each different air spring which contains curb weight air spring pressure, curb weight, gross weight and gross weight air spring pressure allowing weight to be determined as a function of air spring pressure by linear interpolation/extrapolation. More points can be added to the table if desired to increase accuracy and to account for non-linearity's.

During normal operation of the vehicle, the ECU accesses the database and linearly interpolates/extrapolates the data acquired during characterization to calculate the vehicle weight as a function of the ECU measured air spring pressures with the chassis at ride height. In addition, the ECU calculates the payload weight of the vehicle as a function of the vehicle weight.

In a vehicle where payload is desired for the ECU to determine payload there are two ways that this may be accomplished. The first is to replace the table of weights and air spring pressures with a table of payload corresponding to the air spring pressures at both curb and gross weights. This may be determined by subtracting the curb weight from the weights in the vehicle weight table to generate a payload table. The first weight in the table being curb weight would of course become zero when you subtract curb weight from it.

A second way would be to generate the vehicle weight from the weight table as disclosed above and then to subtract the curb weight from it before conveying the weight to the users.

To obtain greater accuracy for the characterization and weight measurement systems described herein, the algorithms can be expanded to include more than two vehicle weights and respective air spring pressures. For example, but not limited to, 3-10 gross vehicle weights and respective air spring pressure can be obtained at the ride height to generate the vehicle characterization data represented by the database accessed by the ECU. The ECU will then interpolate/extrapolate using the closest air spring pressure data to the actual measured air spring pressure. Notably, this additional air spring data can be obtained from actual vehicle weighing and/or from the air spring load data curves.

As a related matter, the methods and systems described herein specifically address a two axle vehicle. However, one, three or more axle vehicles are within the scope of the disclosed methods and systems for characterizing a vehicle and measuring the payload supported by a vehicle chassis. For example, the characterization of a multiple axle system can be handed iteratively, where one axle and corresponding fluid suspension members are completely characterized, then another axle and corresponding fluid suspension members are completely characterized. Alternatively, the characterization process can be performed for all axles and their corresponding fluid suspension members for a first gross vehicle weight, then for a second gross vehicle weight and so on.

During the normal operation of the vehicle, a payload can be measured by summing the weight components associated with the axles.

With reference to FIG. 2, illustrated is a side view of a cargo truck incorporating a payload measurement system according to an exemplary embodiment of this disclosure. FIG. 3 illustrates a sectional view A-A and FIG. 4 illustrates a sectional view B-B of the cargo van.

It is to be understood that the illustrated and described cargo truck is merely one example of an exemplary embodiment of the disclosed methods and systems.

As shown, the illustrated system includes a vehicle 2, i.e. cargo truck, a vehicle chassis 4, i.e. a sprung mass, a front axle 11 and a rear axle 12. Attached to axles 11 and 12 are wheels 3. In addition, a gross axle weight measurement system incorporated into the cargo truck includes two or more air springs, where each air spring includes a flexible sleeve 17, a first end member 15 and a second end member 16. A height sensor 40 is also incorporated into the illustrated system to provide height data associated with the relative displacement of the sprung mass, i.e. the vehicle chassis 4, to the unsprung mass, i.e. the front and/or rear axles 11 and 12, respectively.

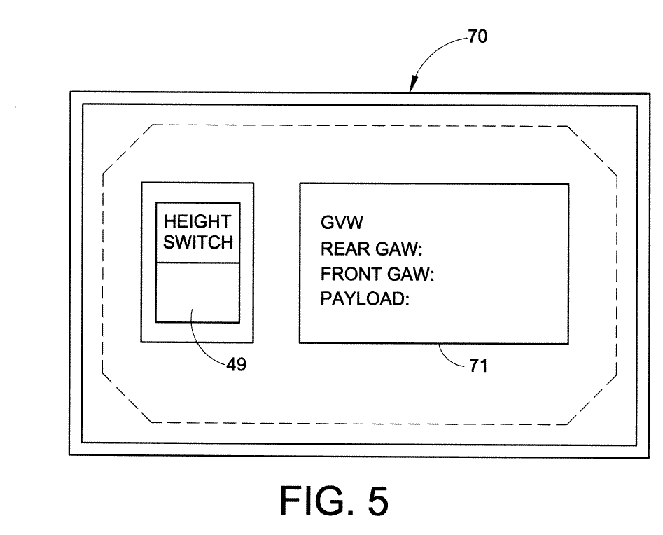

With reference to FIG. 5, illustrated is a diagrammatic view of an exemplary cab mounted display according to an exemplary embodiment of this disclosure.

It is to be understood that the illustrated and described cab mounted display is merely one example of an exemplary embodiment of a display which may be used with the disclosed methods and systems.

As shown, the cab mounted display unit 70 includes a height switch 49 and a display 71 for viewing by an operator of the associated vehicle. The height switch 49, as previously discussed, provides the operator with the ability to raise and lower the vehicle chassis relative to the axles. For example, the operator can depress the switch to raise/lower the vehicle chassis to a height associated with characterizing the vehicle to determine gross axle weights as disclosed herein. The operator may also depress the height switch 49 to activate the fluid suspension system to raise or lower the vehicle chassis to ride height and one or more predetermined heights associated with loading the vehicle. Display 71 provides an operator of the vehicle with a visual indication of the GVW, Rear GAW, Front GAV and Payload associated with the vehicle.

With reference to FIG. 6, illustrated is a flow chart representing a method of characterizing a vehicle to determine the gross axle weight of each axle of a vehicle according to an exemplary embodiment of this disclosure. The exemplary characterization method includes the axle weight measurement of an unloaded vehicle at a predetermined height and the axle weight measurement of a loaded vehicle at the predetermined height.

The method initially starts 80, or is called to be executed by a systems program. According to one exemplary embodiment, the method begins execution via a command by an operator. The command executed using a PC interfaced with an ECU as previously described with reference to FIG. 1.

After the method starts 80, then the characterization method performs the following steps.

Step 1, 82: Adjust the height of the chassis, i.e. sprung mass, to a predetermined height associated with the ride height of the chassis.

Step 2, 84: Measure the gross axle weights of the vehicle unloaded.

Step 3, 86: Measure the air pressure of the air springs.

Step 4, 88: Load the vehicle to approximately the Gross Vehicle Weight Rating (GVWR).

Step 5, 90: Measure the air pressure of the air springs.

Step 6, 92: Compile the gross axle weight and air pressure data acquired in the above steps to create a computer readable database using a computer, the database including data sets representing the measured gross axle weights and respective air pressures.

Step 7, 94: Communicate the database to the ECU.

Step 8, 96: End execution of the characterization method.

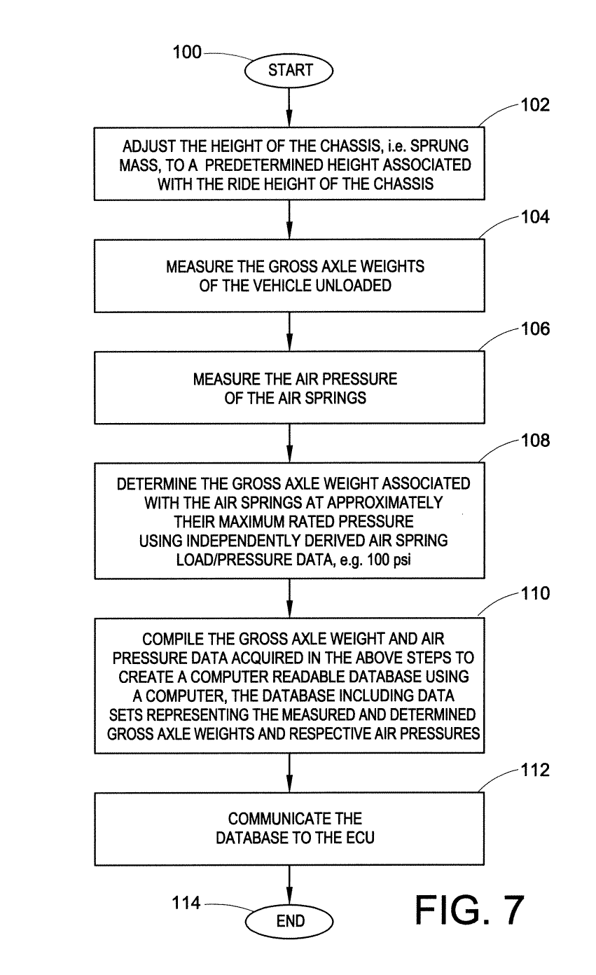

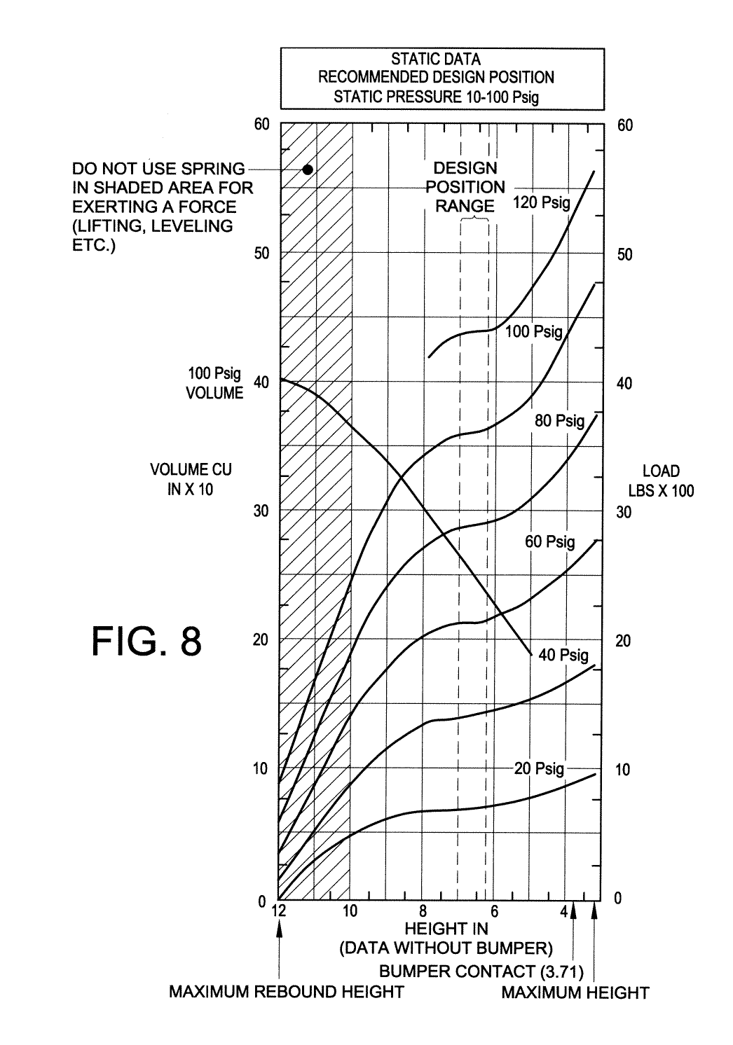

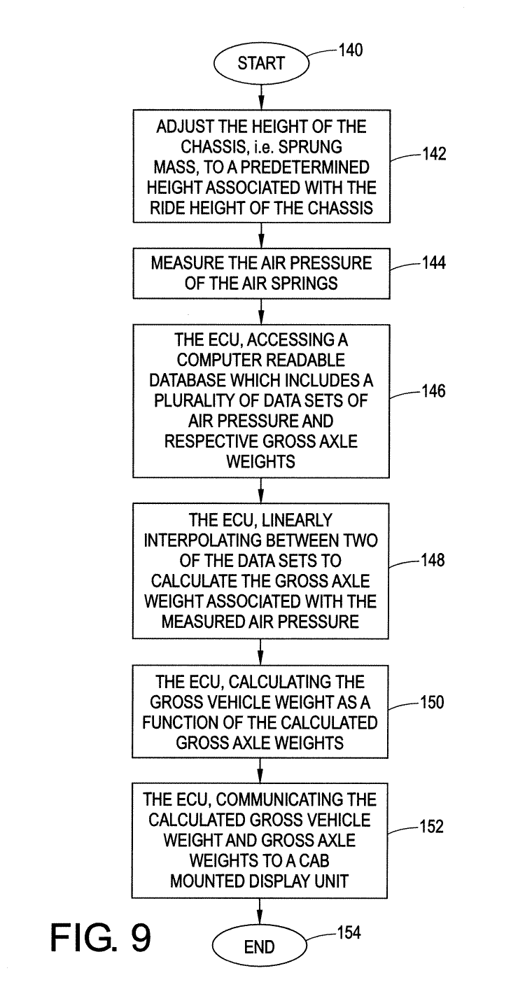

With reference to FIG. 7, illustrated is a flow chart representing a method of characterizing a vehicle to determine the gross axle weight of each axle of a vehicle according to another exemplary embodiment of this disclosure. The exemplary characterization method includes the axle weight measurement of an unloaded vehicle at a predetermined height and determining a loaded vehicle axle weight based on performance data (FIG. 8) associated with one or more fluid suspension members (e.g. air springs).

The method initially starts 100, or is called to be executed by a systems program as described with reference to FIG. 6.

Subsequently to the start 100 of the characterization method, the following steps are performed.

Step 1, 100: The method initially starts.

Step 2, 102: Adjust the height of the chassis, i.e. sprung mass, to a predetermined height associated with the ride height of the chassis.

Step 3, 104: Measure the gross axle weight of the vehicle unloaded.

Step 4, 106: Measure the air pressure of the air springs.

Step 5, 108: Determine the gross axle weight associated with the air springs at approximately their maximum rated pressure using independently derived air spring load/pressure data, e.g. 100 PSI.

Step 6, 110: Compile the gross axle weight and air pressure data acquired in the above steps to create a computer readable database using a computer, the database including data sets representing the measured and determined gross axle weights and respective air pressures.

Step 7, 112: Communicate the database to the ECU.

Step 8, 114: End execution of the characterization method.

With reference to FIG. 9, illustrated is a flow chart representing a method of measuring the axle weight of a payload supported by a vehicle including a fluid suspension system, according to an exemplary embodiment of this disclosure. The exemplary axle weight measurement method includes accessing a database representing the characterization of a vehicle as represented by the flow chart of FIGS. 6 and 7.

The method initially starts 140, or is called to be executed by a systems program.

Subsequent to the start 140 of the axle weight measurement method, the following steps are performed.

Step 1, 142: Adjust the height of the chassis, i.e. sprung mass, to a predetermined height associated with the ride height of the chassis.

Step 2, 144: Measure the air pressure of the air springs.

Step 3, 146: The ECU, accessing a computer readable database which includes a plurality of data sets of air pressure and respective gross axle weights.

Step 4, 148: The ECU, linearly interpolating between two of the data sets to calculate the gross axle weight associated with the measured air pressure.

Step 5, 150: The ECU, calculating the gross vehicle weight as a function of the calculated gross axle weights.

Step 6, 152: The ECU, communicating the calculated gross vehicle weight and gross axle weights to a cab mounted display unit.

Step 7, 154: End execution of the weight measurement method.

Described hereto are methods and systems which characterize a vehicle and measure/display gross axle weights, payload weights and/or vehicle weights associated with a vehicle, where the vehicle is required to be at a predetermined chassis height, such as ride height. According to another aspect of this disclosure, provided are methods and systems to characterize a vehicle, and measure/display gross axle weights, payload weights and/or vehicle weights associated with a vehicle, where the vehicle chassis is at any arbitrary height.

Before describing exemplary embodiments of methods and systems to handle arbitrary vehicle height, a detailed analysis of a vehicle and its suspension system is provided to aid in the understanding of the exemplary embodiments provided.

To determine the weight of a vehicle and/or point of contact weight with the ground (such as a corner wheel) from a point on the vehicle's air suspension, the weight of a load on the vehicle's air spring must be adjusted in order to determine the actual load on the entire suspension or on a point of contact with the ground.

The first such component is a lever arm ratio in which the load supported by the air suspension may be located at a mechanical advantage or mechanical disadvantage relative to the load and a pivot point. The adjustment is not dependant on the height but results in a multiplier being applied to the load on the air spring regardless of height.

A second component is the unsprung mass. This component is also not affected by changes in height and is a constant to be added to the calculated sprung mass to get a total mass.

Other components however, do vary with the height of the vehicle and must be characterized to allow for the determination of weight at any given height on a vehicle. Some such components include bushings and leaf springs which may be fitted to the air spring suspension. As the vehicle's height changes the load that is borne by these suspension components will change which will change the relationship between the load on the air spring and the total load of the vehicle or any subset thereof.

This relationship between the load borne by other suspension components may be described through the use of mathematical equations such as an exponential, nth-order polynomial (including linear which is a 1^{st} order polynomial). Such curves and relationships can change at different heights such as when a leaf spring engages additional leaves or is raised to such a height that it is adding weight supported by the air spring rather than supporting load on the vehicle. Other components such as a bushing tightened on a suspension component will bear no load at the height at which it was tightened but will provide load support at heights lower than the height at which it was tightened and will add loading to the air spring at heights above the height at which it was tightened. Once again the equation and contribution of the bushing will change depending on the change in height of the suspension.

Therefore for any given height, an offset corresponding to loading borne by or placed upon the suspension needs to be added or subtracted from the load calculated from the air spring to get the total sprung mass of the vehicle which can then be added to the unsprung mass to get the total weight. This equation represents a sum of all of the forces being borne by or placed upon the suspension by the non air spring components. For example consider an air suspension having a minimum height of 50 mm, a maximum height of 250 mm and a standard ride height of 150 mm. Consider that the air suspension is of a type commonly known as air over leaf in which an air spring is mounted with a leaf spring to support the load. Consider also a link component attached to the suspension at a location at or about the same as the air spring and leaf spring and attached at the other end at or about the center of the axle and mounted to a bushing that is tightened down while the vehicle is at a height of 150 mm. Consider the weight of the vehicle borne by the air spring to be the variable value X(p) which is calculated as a function of air pressure in the air spring. Consider the weight borne by the leaf spring while at the ride height of 150 mm to be Y and consider the force imposed by the bushing to be zero pounds at a height of 150 mm. The sprung mass of the vehicle is then equal to X(p)+Y.

Now consider that as the vehicle is lowered from 150 mm to 100 mm that the leaf spring bears an additional A pounds of weight for every one mm that the vehicle is lowered. This then changes the weight at the point in question to be X(p)+Y+(A*(150−suspension_height)) over the range of suspension heights from 100 mm to 150 mm. Now also consider that as the suspension is lowered from a height of 150 mm that the bushing increasingly bears weight at a B pounds per every one mm the suspension is lowered. This changes our equation for sprung weight to be X(p)+Y+(A*(150−suspension_height))+(B*(150−suspension height)).

Now consider the suspension as it is further lowered from a height of 100 mm to a height of 50 mm. Consider a suspension in which as the vehicle is lowered from a height of 100 mm to a height of 50 mm that at a height of 100 mm an additional leaf on a leaf spring stack engages causing the leaf spring to bear an increasing weight of C pounds of weight per every one mm the vehicle is lowered. Further consider a system in which the bushing continues to bear additional weight at the same rate over the range from 50 mm to 100 mm as it did over the range from 100 mm to 150 mm of suspension height. The total load now becomes X(p)+Y+(A*50)+(C*(100−suspension_height))+(B*(150−suspension_height)) over the range of suspension heights from 50 mm to 100 mm.

Now consider what happens as the vehicle is raised above a suspension height of 150 mm. As it is raised the leaf spring now supports some weight that is less than the weight (Y) it supports at a suspension height of 150 mm. Consider that the particular leaf spring supports A fewer pounds per every one mm that the suspension is raised. This value happens to correspond to the same change in weight as the vehicle is lowered which in many practical vehicles would happen to be the case. It is understood however that this would not have to be the case. This would result in the weight being borne by the leaf spring corresponding to Y−(A*(suspension_height−150)). Now consider the bushing which at the suspension height of 150 mm contributes no force on the suspension. As the suspension is raised it opposes the raising of the suspension placing additional loading on the air spring even though there is no additional weight. Let's consider a suspension in which the opposing force applied as the vehicle is raised happens to-be the same as the load supported as the vehicle is lowered-so that the bushing provides an opposing force of B pounds per every mm the vehicle is raised producing a bushing component corresponding to B*(150−suspension_height). The formula at this point for the load at the suspension point would become X(p)+Y−(A*(suspension_height−150))−(B*(suspension_height−150)).

Now consider a system in which at a suspension height of 200 mm the leaf spring no longer supports any load. That is where the leaf spring is supporting a load of Y−(A*(200−150)) is equal to zero and therefore Y=(A*50). As the suspension is further raised the leaf spring will now oppose the air spring in the raising of the vehicle. So now as the vehicle is raised from a suspension height of 200 mm to a suspension height of 250 mm the leaf spring now opposes raising the suspension by a force of D pounds per every one mm that the suspension is raised. Also, consider that the bushing continues to oppose movement by the same amount as when moving from a height of 150 mm to 200 mm then the total weight now becomes X(p)−(D* (suspension_height 200)−(B*(suspension_height−150) over the range of suspension_heights from 200 mm to 250 mm.

It is understood that the analysis provided is merely illustrative. The number of points at which rates of change of weight with height may be any number appropriate and may occur on either side or at ride height and the multiple rates for heights above the height at which the leaf spring presents an opposing force may also exists. It is also understood that while it is common to setup a suspension so that the bushing presents no loading at ride height that this may not be the case and could be placed at any height. It is further understood that the rate of the bushing may vary and there may be many points at which it may change. It is also understood that even though in the above example that the change in loading is presented as a linear function of height that this is not a limitation of this disclosure and it may be described by any appropriate mathematical equation.

In order to go through the complete process of calculating the weight the pressure in the air spring must be determined and may commonly be read through use of a pressure transducer that is pneumatically connected to the air spring and that the height must be calculated and this may be accomplished through the use of a height sensor attached at the suspension point. It is also understood that this would be commonly accomplished through aftaching the pressure transducer and the height sensor to an Electronic Control Unit that then calculates and may display the calculated weight. It is also understood that this ECU may have other functionality such as but not limited to controlling the height of an air suspension. It is also understood that the example shows for one such point of attachment between a sprung mass and an unsprung mass and that there may be multiple such points in which the weights for each point may be summed to obtain a total weight. It is also understood that an unsprung mass may be added to the calculated sprung mass to determine a total weight. Furthermore it is understood that in the calculated air spring weight (X(p)) may contain a multiplier to adjust for any mechanical advantage or disadvantage that the air spring may have. Furthermore it is understood that this may be expanded to any component that supports weight which may be characterized and whose weight supported changes as a function of suspension height.

One exemplary method of characterizing a vehicle to determine the payload weight/vehicle weight at an arbitrary height is in the design of the suspension to create mathematical models that describe the suspension components and sum such models for various components. The sum of the models then correctly describes the loading on the components over the range of suspension travel of the vehicle.

A second exemplary method of characterizing a vehicle to determine the payload weight/vehicle weight at an arbitrary height is to empirically determine points at which the curve changes and construct a piecewise continuous curve that calculates a weight as a function of both the height of the suspension and the pressure in the air spring. Data can be entered regarding the load characteristics of the air spring and total load on the vehicle at a variety of heights and weights wherein the weight supported by the air spring is compared with the total weight to determine the load carried at a variety of heights to generate points to fit to an appropriate curve whose shape may be assumed or explicitly specified as appropriate for the suspension.

A third exemplary method of characterizing a vehicle to determine the payload weight/vehicle weight at an arbitrary height is to sample a sufficient number of points at varying heights at or near the curb weight and at or near gross weight to construct a piecewise continuous curve for both a weight at or near curb weight and at or near gross weight allowing for either interpolation or extrapolation to calculate the weight of the vehicle throughout the height range of the suspension.

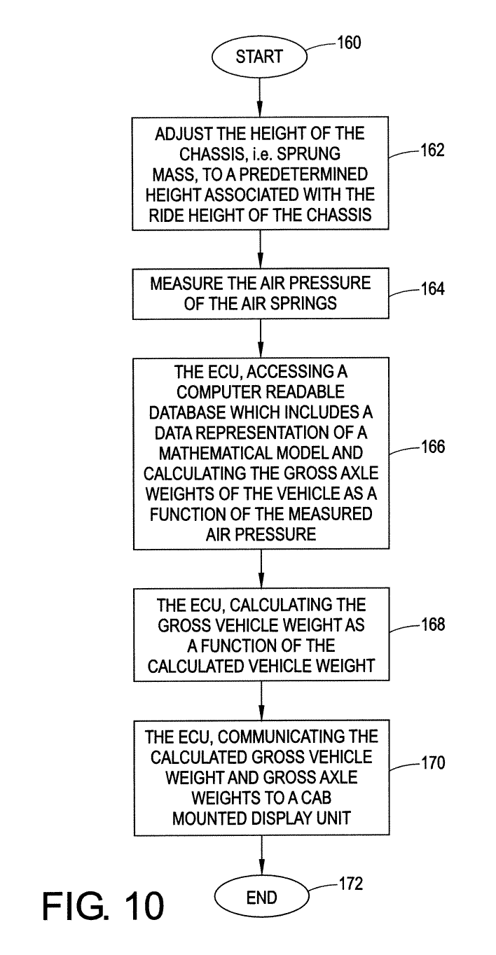

With reference to FIG. 10, illustrated is a flow chart representing a method of measuring and displaying the axle weights of a vehicle including a fluid suspension system, according to another exemplary embodiment of this disclosure.

The exemplary axle weight measurement method includes accessing a database representing a mathematical model of the vehicle.

The method initially starts 160 or is called to be executed by a systems program.

Subsequent to the start 160 of the method to measure and display the axle weights of the vehicle, the following steps are performed.

Step 1, 160: Start of the method.

Step 2, 162: Adjust the height of the chassis, i.e. sprung mass, to a predetermined height associated with the ride height of the chassis.

Step 3, 164: Measure the air pressure of the air springs.

Step 4, 166: The ECU, accessing a computer readable database which includes a data representation of a mathematical model and calculating the gross axle weights of the vehicle as a function of the measured air pressure.

Step 5, 168: The ECU, calculating the gross vehicle weight as a function of the calculated vehicle weight.

Step 6, 170: The ECU, communicating the calculated gross vehicle weight and gross axle weights to a cab mounted display unit.

Step 7, 172: End execution of the axle weight measurement and display method.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. A method of characterizing a vehicle to determine gross axle weights associated with the vehicle, the vehicle including a sprung mass operatively associated with supporting a payload, an unsprung mass including two or more axles, and a fluid suspension system operatively associated with supporting the sprung mass and controlling the height of the sprung mass relative to the unsprung mass, the fluid suspension system including one or more fluid suspension members operatively disposed between the sprung mass and the axles, a fluid control device, a pressurized fluid source, an exhaust passage in fluid communication with the one or more fluid suspension members through the fluid control device, one or more pressure sensors operatively associated with the fluid suspension members, and an electronic control unit operatively associated with the fluid control device, the method of characterizing the vehicle comprising:
a) measuring a first gross axle weight of each axle of the vehicle unloaded;
b) adjusting the height of the sprung mass, relative to the unsprung mass, to a predetermined height by one of supplying fluid to the fluid suspension members and exhausting fluid from the fluid suspension members;
c) measuring a first pressure associated with each of the fluid suspension members;
d) loading the sprung mass with a characterization load;
e) measuring a second gross axle weight of each axle of the vehicle loaded with the characterization load;
f) adjusting the height of the sprung mass, relative to the unsprung mass, to the predetermined height by one of supplying fluid to the one or more fluid suspension members and exhausting fluid from the one or more fluid suspension members;
g) measuring a second pressure associated with each of the fluid suspension members; and
h) creating a computer readable database which correlates a plurality of pressures associated with the fluid suspension members with a gross axle weight of the respective axles with the fluid suspension members supporting the sprung mass at the predetermined height, wherein the first gross axle weights and the respective measured first pressures provide a first data set, and the second gross axle weights and the respective measured second pressures provide a second data set to create the database.

2. The method according to claim 1, wherein a computer executes program instructions to display instructions to a user to perform steps a)-g) and the computer executes program instructions to perform step h).

3. The method according to claim 2, wherein the computer executes instructions to communicate the database to a computer readable storage medium which is accessible by the electronic control unit for determining the gross axle weight of each axle with the sprung mass at the predetermined height.

4. The method according to claim 1, further comprising one or more of 1) storing the database on a computer readable medium, 2) communicating the database to the electronic control unit and 3) further processing the database.

5. The method of characterizing a vehicle according to claim 1, wherein steps b) and c) are repeatedly performed for a plurality of predetermined heights associated with the vehicle unloaded, steps f) and g) are repeatedly performed for the plurality of heights, and step h) creates a computer readable database which correlates the pressure associated with the fluid suspension members with a plurality of gross axle weights of the respective axles with the fluid suspension members supporting the sprung mass at the plurality of predetermined heights, wherein the database includes a plurality of data sets associated with measured gross axle weights, measured pressures and the respective predetermined height of the sprung mass relative to the unsprung mass.

6. A method of characterizing a vehicle to determine gross axle weights associated with the vehicle, the vehicle including a sprung mass operatively associated with supporting a payload, an unsprung mass including two or more axles, and a fluid suspension system operatively associated with supporting the sprung mass and controlling the height of the sprung mass relative to the unsprung mass, the fluid suspension system including one or more fluid suspension members operatively disposed between the sprung mass and the axles, a fluid control device, a pressurized fluid source, an exhaust passage in fluid communication with the fluid suspension members through the fluid control device, one or more pressure sensors operatively associated with the fluid suspension members, and an electronic control unit operatively associated with the fluid control device, the method of characterizing the vehicle comprising:
a) measuring gross axle weight of each axle with the vehicle unloaded;
b) adjusting the height of the sprung mass, relative to the unsprung mass, to a predetermined height by one of supplying fluid to the fluid suspension members and exhausting fluid from the fluid suspension members;
c) measuring a first pressure associated with each of the fluid suspension members;
d) determining a second gross axle weight of each axle for a second pressure associated with the fluid suspension members, the second pressure greater than the first pressure and the second gross axle weight of the axles determined by accessing load data associated with the fluid suspension members, wherein the load data provides one or more sprung mass weights for one or more respective pressures associated with the fluid suspension members at a height associated with the predetermined sprung mass height, and the second gross axle weight of the axles is calculated as a function of the first gross axle weight, the first pressure, the sprung mass weight for the second pressure and the second pressure; and
e) creating a computer readable database which correlates a plurality of pressures associated with the fluid suspension members with a plurality of gross axle weights of the respective axles with the fluid suspension members supporting the sprung mass at the predetermined height, wherein the first gross axle weights and the respective measured first pressures provide a first data set, and the second gross axle weights and the respective measured second pressures provide a second data set to create the database.

7. The method according to claim 6, wherein a computer executes program instructions to display instructions to a user to perform steps a)-d) and the computer executes program instructions to perform step e).

8. The method according to claim 7, wherein the computer executes instructions to communicate the database to a computer readable storage medium which is accessible by the electronic control unit for determining the gross axle weight of each axle with the sprung mass at the predetermined height.

9. The method according to claim 8, further comprising one or more of 1) storing the database on a computer readable medium, 2) communicating the database to the electronic control unit and 3) further processing the database.

10. The method according to claim 6, wherein step d) calculates the second gross axle weights of each axle according to the equation
GAW₂=GAW₁+SMW₂−((GAW₁P₁/GAW₂P₂)*SMW₂)
where
GAW₁ represents the first gross axle weight of an axle,
GAW₂ represents the calculated second gross axle weight of any axle,
SMW₂ represents the sprung mass weight for the second pressure provided by the load data,
GAW₁P₁ represents the first pressure, and
GAW₂P₂ represents the second pressure.

11. The method of characterizing a vehicle according to claim 6, wherein steps b) and c) are repeatedly performed for a plurality of predetermined heights associated with the vehicle unloaded, step d) is repeatedly performed for a plurality of predetermined sprung mass heights to determine respective second gross axle weights at the second pressure, and step e) creates a computer readable database which correlates a plurality of pressures associated with the fluid suspension members with a plurality of gross axle weights of the respective axles with the weight and the one or more fluid suspension members supporting the sprung mass at the plurality of predetermined heights, wherein the database includes a plurality of data sets associated with gross axle weight, the respective pressure and the respective predetermined height of the sprung mass relative to the unsprung mass.

12. A method of measuring the gross axle weight of each axle associated with a vehicle, the vehicle including a sprung mass operatively associated with supporting a payload, an unsprung mass, and a fluid suspension system operatively associated with supporting the sprung mass and controlling the height of the sprung mass relative to the unsprung mass including two or more axles, the fluid suspension system including one or more fluid suspension members operatively disposed between the sprung mass and the axles, a fluid control device, a pressurized fluid source, an exhaust passage in fluid communication with the one or more fluid suspension members through the fluid control device, one or more pressure sensors operatively associated with the fluid suspension members, and an electronic control unit operatively associated with the fluid control device, the method of measuring the gross axle weight of each axle comprising:
a) adjusting the height of the sprung mass, relative to the unsprung mass, to a predetermined height by one of supplying fluid to the one or more fluid suspension members and exhausting fluid from the one or more fluid suspension members;
b) measuring a pressure associated with the fluid suspension members; and
c) the electronic control unit, determining the gross axle weight of each axle by accessing a computer readable database which correlates the pressure associated with the fluid suspension members with the gross axle weight of the axle and the fluid suspension members supporting the sprung mass at the predetermined height, wherein the computer readable database is generated by the method of claim 1.

13. The method according to claim 12, step c) further comprising:
performing one of interpolation and extrapolation from the first and second data sets to determine the gross weight of each axle.

14. A method of measuring the gross axle weight of each axle associated with a vehicle, the vehicle including a sprung mass operatively associated with supporting a payload, an unsprung mass including two or more axles, and a fluid suspension system operatively associated with supporting the sprung mass and controlling the height of the sprung mass relative to the unsprung mass, the fluid suspension system including one or more fluid suspension members operatively disposed between the sprung mass and the axles, a fluid control device, a pressurized fluid source, an exhaust passage in fluid communication with the fluid suspension members through the fluid control device, one or more pressure sensors operatively associated with the one or more fluid suspension members, and an electronic control unit operatively associated with the fluid control device, the method of measuring the gross axle weight of each axle comprising:
a) adjusting the height of the sprung mass, relative to the unsprung mass, to a predetermined height by one of supplying fluid to the one or more fluid suspension members and exhausting fluid from the one or more fluid suspension members;
b) measuring a pressure associated with the one or more fluid suspension members; and
c) the electronic control unit, determining the gross axle weight of each axle by accessing a computer readable database which correlates the pressure associated with the fluid suspension members with the gross axle weight of the axle and the fluid suspension members supporting the sprung mass at the predetermined height, wherein the computer readable database is generated by the method of claim 6.

15. The method according to claim 14, wherein the computer readable database is generated by the method of claim 10.

16. The method according to claim 14, step c) further comprising:
performing one of interpolation and extrapolation from the first and second data sets to determine the gross axle weight of each axle.

17. A gross axle weight measurement and display system for a vehicle including an unsprung mass and a sprung mass operatively associated with supporting a payload comprising:
one or more fluid suspension members operatively disposed between the sprung mass and the unsprung mass;
a fluid control device;
a pressurized fluid source;
an exhaust passage in fluid communication with the one or more fluid suspension members through the fluid control device;
one or more pressure sensors operatively associated with the one or more fluid suspension members;
a height sensor operatively associated with measuring the height of the sprung mass relative to the unsprung mass;
a display unit; and
an electronic control unit operatively associated with the fluid control device, the one or more pressure sensors, the height sensor, and the display unit, the electronic control unit configured to execute instructions that, when executed by the control unit, cause the control unit to perform a method comprising:
a) determining that the sprung mass is at a predetermined height relative to the unsprung mass by communicating with the height sensor;
b) communicating with the one or more pressure sensors to measure the pressure associated with the one or more fluid suspension members with the height of the sprung mass at the predetermined height relative to the unsprung mass;
c) accessing a computer readable database which correlates the pressure associated with the one or more fluid suspension members with the gross axle weight of each axle and the fluid suspension members supporting the sprung mass at the predetermined height, the computer readable database including a first data set associated with a first gross axle weight and a respective measured first pressure, and a second data set associated with a second gross axle weight and a respective second pressure, the first and second data sets generated by the method of claim 1, and
d) calculating the gross axle weights as a function of the measured pressure, the first data set and the second data set; and
e) communicating the calculated gross axle weights to the display unit.

18. The gross axle weight measurement system according to claim 17, step d) further comprising:
performing one of interpolation and extrapolation from the first and second data sets to calculate the gross axle weights.

19. A gross axle weight measurement and display system for a vehicle including an unsprung mass and a sprung mass operatively associated with supporting a payload comprising:
one or more fluid suspension members operatively disposed between the sprung mass and the unsprung mass;
a fluid control device;
a pressurized fluid source;
an exhaust passage in fluid communication with the one or more fluid suspension members through the fluid control device;
one or more pressure sensors operatively associated with the one or more fluid suspension members;
a height sensor operatively associated with measuring the height of the sprung mass relative to the unsprung mass;
a display unit; and
an electronic control unit operatively associated with the fluid control device, the one or more pressure sensors, the height sensor and the display unit, the electronic control unit configured to execute instructions that, when executed by the control unit, cause the control unit to perform a method comprising:
a) determining that the sprung mass is at a predetermined height relative to the unsprung mass by communicating with the height sensor;
b) communicating with the one or more pressure sensors to measure the pressure associated with the one or more fluid suspension members with the height of the sprung mass at the predetermined height relative to the unsprung mass;
c) accessing a computer readable database which correlates the pressure associated with the fluid suspension members with the gross axle weight of each axle and the fluid suspension members supporting the sprung mass at the predetermined height, the computer readable database including a first data set associated with a first gross axle weight and a respective measured first pressure, and a second data set associated with a second gross axle weight and a respective second pressure, the first and second data sets generated by the method of claim 6;
d) calculating the vehicle weight as a function of the measured pressure and the first data set and the second data set; and
e) communicating the calculated gross axle weight to the display unit.

20. The gross axle weight measurement system according to claim 19, step d) further comprising:
performing one of interpolation and extrapolation from the first and second data sets to calculate the gross axle weights.
